(19) United States
(12) Patent Application Publication
(10) Pub. No.: US 2019/0266683 A1
(43) Pub. Date: Aug. 29, 2019

(54) Method and System for Automated Real Estate Information and Offers

(71) Applicant: Greg Burns, Lahaina, HI (US)

(72) Inventor: Greg Burns, Lahaina, HI (US)

(21) Appl. No.: 16/159,654

(22) Filed: Oct. 13, 2018

Related U.S. Application Data
(60) Provisional application No. 62/636,584, filed on Feb. 28, 2018.

(51) Int. Cl. G06Q 50/16; G06Q 30/00; G06F 17/30

(52) U.S. Cl. CPC G06Q 50/163; G06F 17/3087; G06Q 30/016

(57) ABSTRACT

In a method and system for automated real estate information and offers, a prospective buyer of real property points a camera of a mobile device at the property. An application on the mobile device retrieves information pertinent to the property from a remote database, based on a geographic location of the property and automatic image recognition of one or more written characters displayed on or near the property. A form in the application takes terms for a prospective offer to purchase the property. The application transmits the offer to be displayed as an advertisement on one or more of the property owner's devices. The application permits prospective buyer and prospective seller to identify, negotiate with, and select real estate service providers including agents, brokers, title companies, escrow companies, and inspectors, each of whom may upload and download documents and information through the application.

### RELATED APPLICATION

This application is related to and claims benefit of U.S. Provisional Application Ser. No. 62/636,584, which is incorporated by reference herein.

### FIELD OF THE INVENTION

The present invention generally relates to real estate and related mobile device and computer technology, and more particularly to methods and systems for automating retrieving real estate information and making offers for purchase via a mobile device application.

### BACKGROUND

In today's world of real estate, offers are submitted and negotiated by real estate agents. The seller pays a commission to its agent who in turn pays the buyer's agent a portion of the commission, based on the listing agreement.

A prospective property buyer, e.g., a prospective homebuyer, can search public listings for available properties. In addition, a prospective purchaser can contact a buyer's agent, who may offer expertise in effectively searching listed properties, arranging to tour listed properties, and negotiating terms for a contemplated purchase of a listed property.

A prospective seller, e.g., a prospective home seller, can create an advertisement (e.g., a “For Sale” sign in the yard, a newspaper ad, an online classifieds ad, a web site, etc.) to publicize the subject property's availability on the market. In addition, a prospective seller can contact a seller's agent, who may offer expertise in effectively promoting the subject property, including to create an information data exchange (IDX) record (e.g., multiple listing service (MLS) listing) by which the fact of the subject property's availability on the market may be disseminated to prospective buyers and their agents, along with information pertinent to the subject property (e.g., acreage, square footage of improvements, age of improvements, number of bedrooms, number of bathrooms, types of available utilities, sales history, tax history, etc.).

Some real estate search platforms permit property owners to create quasi-listings to test the market and gauge potential interest without officially listing their property for sale. For example, Zillow.com has permitted users to post “Make Me Move” listings, to publicize a price at which the owner would consider selling a given property. In such systems, the posting may be anonymous to safeguard the owner's identity. In this way, the owner can become a prospective seller, while foregoing the formalities of an official “For Sale” listing.

However, in conventional systems, the set of properties available to a prospective buyer is limited by the number and identity of prospective sellers who preemptively advertise the properties they wish to offer for sale. That is, unless the owner of a subject property takes an affirmative step to advertise the property's availability on the market, the owner is unlikely to receive an offer from any prospective buyer to purchase the subject property. In addition, some owners hesitate to list their properties due to the belief (well-founded or not) that listing a property for sale can entail significant costs (e.g., advertising, agent fees, repairs and cosmetic touch-ups, etc.) and burdens (e.g., staging for tours, vacating the property during open-houses, etc.).

In general, properties not listed for sale tend to be excluded from a prospective buyer's search and there are comparatively few cases where a prospective buyer approaches an owner (e.g., by knocking on the door in person, by mail, through an agent, etc.) to make an offer to purchase an unlisted property.

Under these conditions, prospective buyers can miss out on properties that would better suit the buyers' preferences as compared to listed properties and quasi-listed properties. Moreover, owners (prospective sellers) can miss out on opportunities to sell their properties, simply because they are not aware that prospective buyers are willing to purchase the owners' properties on terms that the owners would be willing to accept.

Furthermore, technologically, there is no simple and easy conventional way for a prospective buyer to make an offer for off-market properties, for example, to a homeowner from a mobile device application.

Accordingly, there is a desire for prospective buyers to be able to more effectively propose to a property owner terms for an offer to purchase the owner's property, particularly where the property is not actively listed for sale. Likewise, there is a desire by owners (prospective sellers) to obtain real estate market information without incurring undue costs or burdens.

### SUMMARY

In one embodiment, a method in a data processing system for retrieving real estate information and automatically delivering an offer to purchase real estate is provided, comprising acquiring an image of a property by a camera of a mobile computing device, and determining a geographic location of the property by the mobile computing device. The method further comprises querying a database by the mobile computing device to retrieve property information corresponding to the geographic location, and determining from the property information a contact information for an owner of the property. The method also comprises transmitting to the owner a communication regarding the property based on the contact information.

A data processing system for retrieving real estate information and automatically delivering an offer to purchase real estate is provided, comprising a mobile computing device. The mobile computing device further comprises a camera, a processor and a memory storing instructions that, when executed by the processor, configure the mobile computing device to acquire an image of a property by the camera of the mobile computing device, and determine a geographic location of the property. The mobile computing device is further configured to query a database to retrieve property information corresponding to the geographic location, and determine from the property information a contact information for an owner of the property. The mobile computing device is also configured to transmit to the owner a communication regarding the property based on the contact information.

### BRIEF DESCRIPTION OF DRAWINGS

FIG. 1 illustrates a computer system and device in accordance with an embodiment;

FIG. 2 illustrates a network with servers and computers or devices in accordance with an embodiment;

FIGS. 3A-H shows a process in accordance with an embodiment;

FIGS. 4A-D show a user interface of a device and system in accordance with an embodiment;

FIG. 5A shows a device and system in accordance with an embodiment for contacting an owner through an advertising network; and

FIG. 5B shows a process in accordance with an embodiment for contacting an owner through an advertising network.

### DETAILED DESCRIPTION

Methods and systems in accordance with the present invention allow a user to automatically indicate interest in buying a property to the owner of the property by aiming a smartphone camera and taking a picture of the property on the smartphone. The system may also provide information on the property or home to the user. GPS data and Internet Protocol (IP) address tracking may be used to automatically identify the property and the property's owner. The system may send, for example, an email to the owner indicating the prospective buyer's interest in buying the property.

The system may be implemented in a smart phone application, for example, that a prospective buyer may use after driving down a street looking at homes. The buyer can stop, open the app, and point the viewfinder and camera at a house to obtain more information on the house, as well as possibly contacting the owner to see if they might be interested in selling. This initial contact may be made through IP address tracking technology and email, but after that, subsequent communication can be done through a chat platform built into the app. Flexibility possessed by the system resides in its ability to allow both sellers and buyers to initiate the conversation, and then have agents brought in to finalize the terms and push it to finalization and recordation.

In one implementation, it allows the average consumer to drive by a property and point their camera viewer when running the application at an address allowing for number recognition and GPS coordinates to match the property to the criteria. The buyer may view data about the home with or without taking a picture, just by pointing the viewer at the home. The system utilizes property tax addresses, email and/or other tracking abilities to identify the property and the owner.

Furthermore, a buyer can provide an owner an offer to purchase the home. The app can include an “offer sheet” form that allows buyer and seller to fill-out the majority of the terms that most contracts have. Such forms can be saved and submitted. A buyer can decide to invite an agent to help present the offer, or the app can present the offer via IP address tracking-based technology using, for example, targeted ad technology. If the owner agrees to sell, then both the buyer and seller can select from a group of qualified agents. This is an advantageous tool for consumers as they become more and more savvy to the home search and purchasing process, but it is also advantageous for agents as the quality of leads is superior to conventional systems. Another option is a less formal “are you interested in selling” type of inquiry, and agents or buyers can both make such inquiries.

The system may be implemented in a software platform that offers users the ability to use a phone's camera interface coupled with number recognition (of an address for example), GPS coordinates and cellular tower triangulation to submit offers to purchase real estate with offers directly submitted to the property owner's computer screen through IP address tracking. In one implementation, a transaction may still require a local agent to complete the deal, but many facets of a deal have been agreed to allowing the agent to have a very qualified lead which is acquired through a network of referral agents participating in an active campaign paying, for example, a licensee to be connected with the buyer and/or sellers.

This system pertains generally to the ability to use numeric character identification and GPS location data followed by IP address tracking to allow for a new way of buyers and sellers to do a transaction as well as a better way to obtain more qualified leads from the software. The process allows for real estate agents to spend less effort filtering and qualifying already expensive leads as well as allowing sellers to save some commission by having a pre-negotiated contract in which any participating agent agrees to a lower commission payment to the buyer's and seller's agents for any transaction. The software includes the ability to use the GPS coordinates of the phone or mobile device to obtain homeowner information which in turn, through IP address tracking, a message can appear on the screen of the homeowner's computer. A homeowner can directly respond to the offer, and many of the terms of a contract can be agreed upon between homeowner and the person who submitted the offer. Once the main terms have been negotiated including price, the software is then further utilized by real estate agents as it provides very qualified leads to them via already agreed upon “offer sheets” provided by the software's back end lead distribution network. The software application provides highly valuable pre-negotiated leads with acceptance already designated by the seller and the buyer.

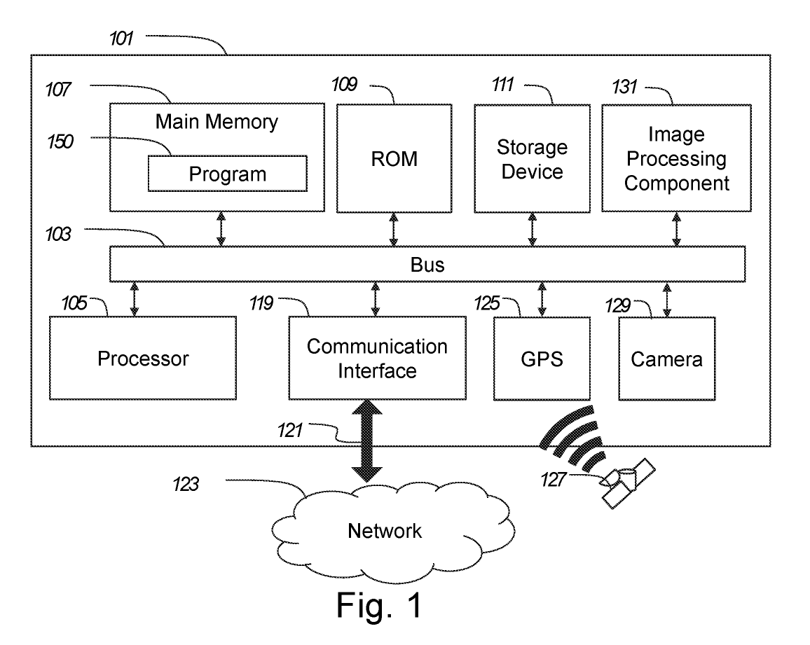

FIG. 1 illustrates an exemplary computer 101 consistent with systems and methods of the present invention. Computer 101 includes a bus 103 or other communication mechanism for communicating information, and a processor 105 coupled with bus 103 for processing the information. Computer 101 also includes a main memory 107, such as a random access memory (RAM) or other dynamic storage device, coupled to bus 103 for storing information and instructions to be executed by processor 105. In addition, main memory 107 may be used for storing temporary variables or other intermediate information during execution of instructions to be executed by processor 105. Main memory 107 includes a program or application (app) 150 consistent with methods and systems of the present invention. Computer 101 further includes a read only memory (ROM) 109 or other static storage device coupled to bus 103 for storing static information and instructions for processor 105. A storage device 111, such as a flash drive, magnetic disk or optical disk, is provided and coupled to bus 103 for storing information and instructions. Computer 101 may be a personal computer, a server, a laptop, a smartphone, a wearable device, a mobile device, a tablet, smart glasses, or any other digital device equipped with appropriate input, output, and processing capabilities.

According to one embodiment, processor 105 executes one or more sequences of one or more instructions contained in main memory 107. Such instructions may be read into main memory 107 from another computer-readable medium, such as storage device 111. Execution of the sequences of instructions in main memory 107 causes processor 105 to perform process steps described herein and/or consistent with an exemplary embodiment. One or more processors in a multi-processing arrangement may also be employed to execute the sequences of instructions contained in main memory 107. Thus, in some embodiments, the sequences of instructions configure the computer 101 to perform predetermined tasks, operations, programs, or applications. In alternative embodiments, hard-wired circuitry may be used in place of or in combination with software instructions. Thus, embodiments are not limited to any specific combination of hardware circuitry and software.

Although described relative to main memory 107 and storage device 111, instructions and other aspects of methods and systems consistent with the present invention may reside on another computer-readable medium, such as a floppy disk, a flexible disk, hard disk, flash drive, magnetic tape, a CD-ROM, magnetic, optical or physical medium, a RAM, a PROM, an EPROM, a FLASH-EPROM, any other memory chip or cartridge, or any other medium from which a computer can read.

Computer 101 also includes a communication interface 119 coupled to bus 103. Communication interface 119 provides a two-way data communication coupling to a network link 121 that is connected to a network 123, such as the Internet or other computer network. Wireless links may also be implemented. In any such implementation, communication interface 119 sends and receives signals that carry digital data streams representing various types of information.

In one implementation, computer 101 may operate as a web server on a computer network 123 such as the Internet. Computer 101 may also represent other computers on the Internet, such as users' computers having web browsers, and the user's computers may have similar components as computer 101 or mobile devices.

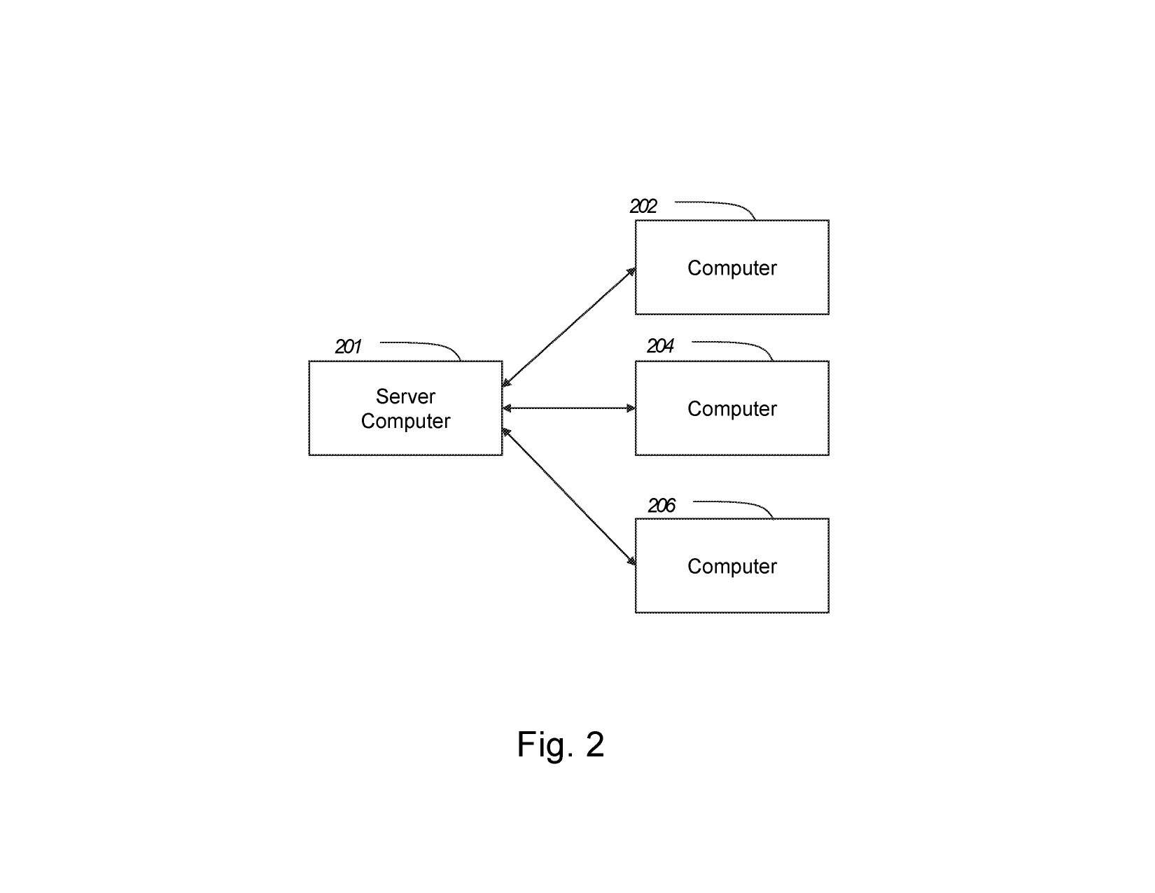

FIG. 2 shows an exemplary computer network such as the Internet having a web server for a website and computers used by various potential participants. As described above, computer 101 may be a server having the components described above and may implement methods and systems consistent with the present invention. Computers 201, 202, 204, and 206 may include web browsers and may be used by users to access the Internet or other network and access computer 101. There may be any number of user computers and any number of server computers. Users of computers 201, 202, 204, and 206, for example, may be buyers and sellers on the real estate system by accessing the computer 101. These computers may be operated by these participants. The computers 201, 202, 204 and 206 may also represent mobile devices running the smart phone application described herein.

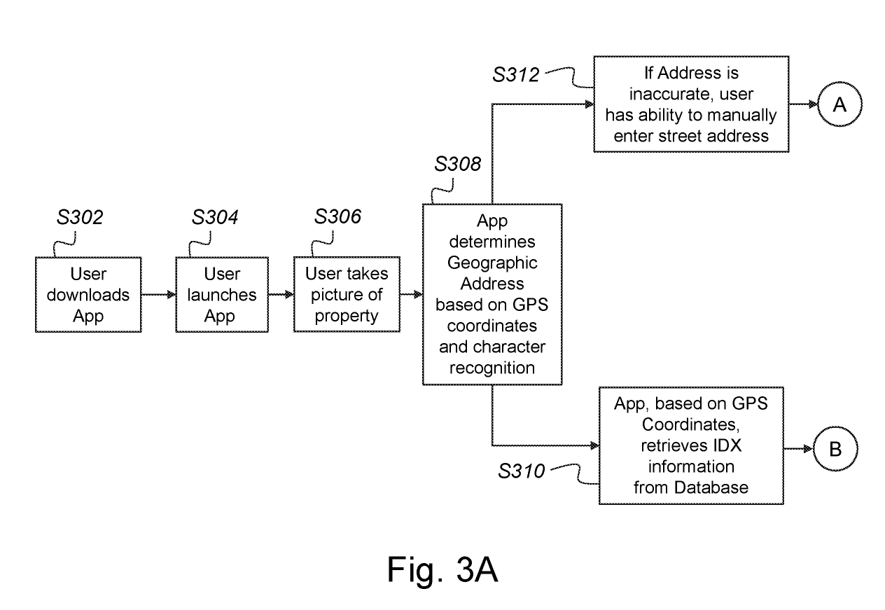

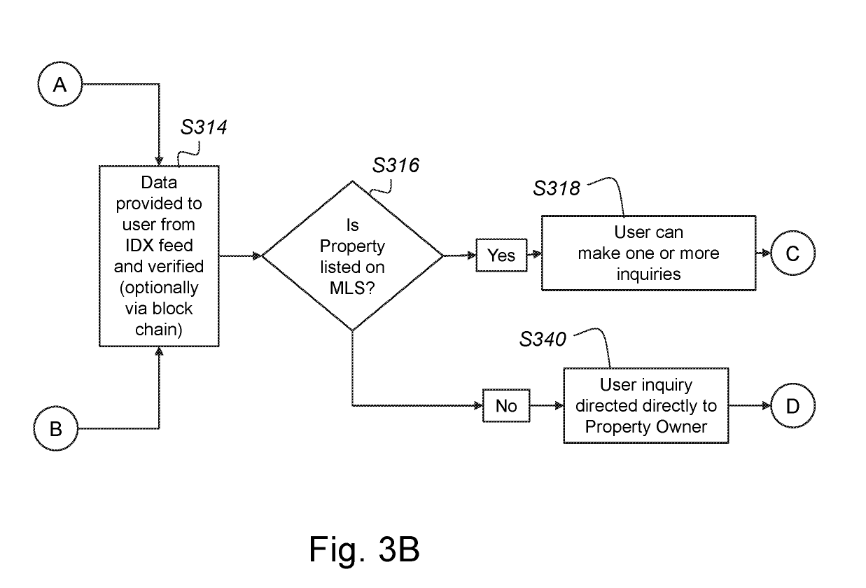

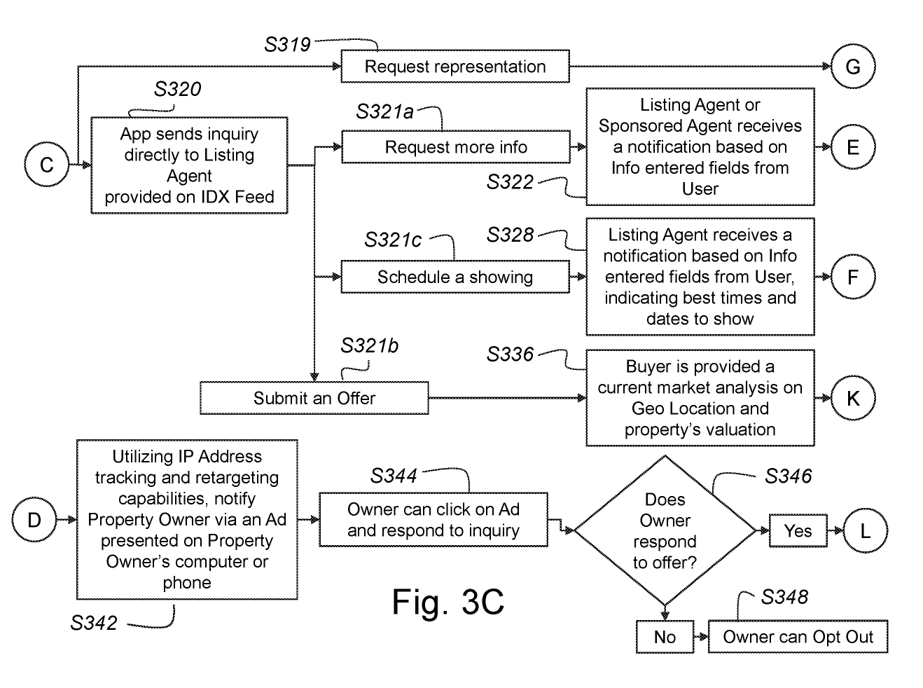

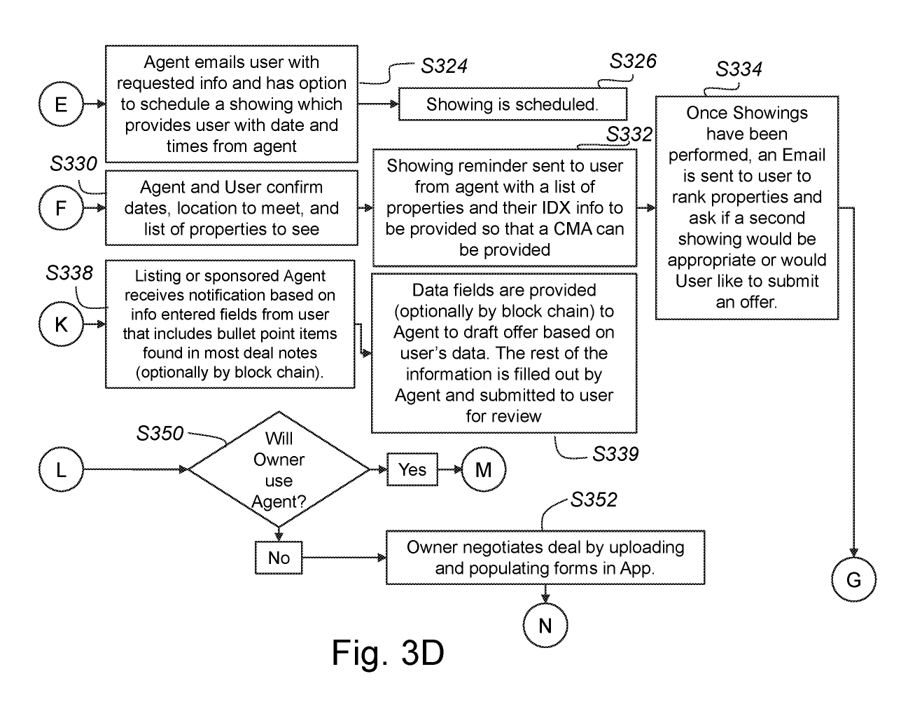

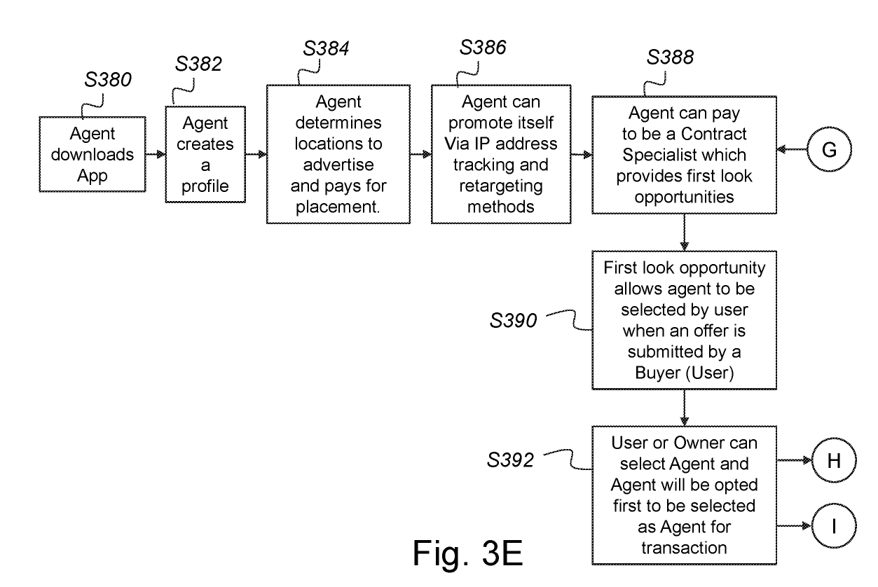

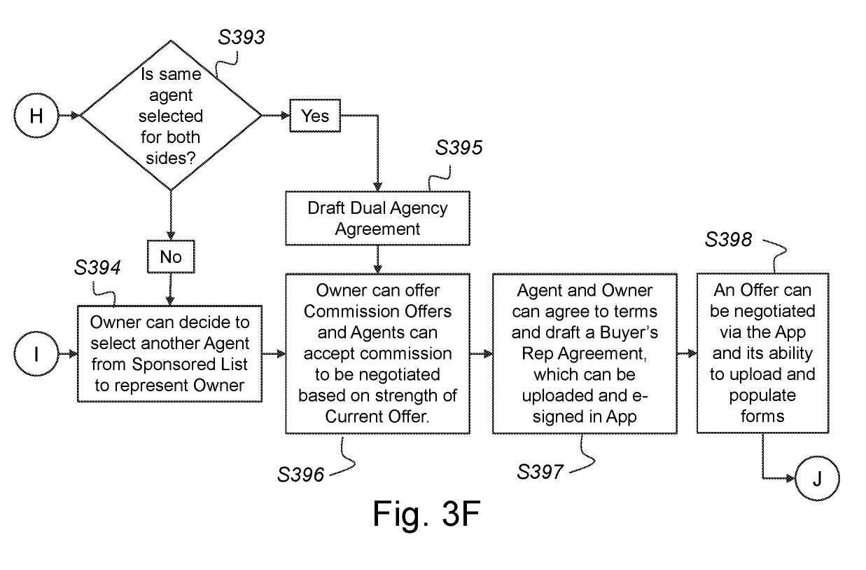

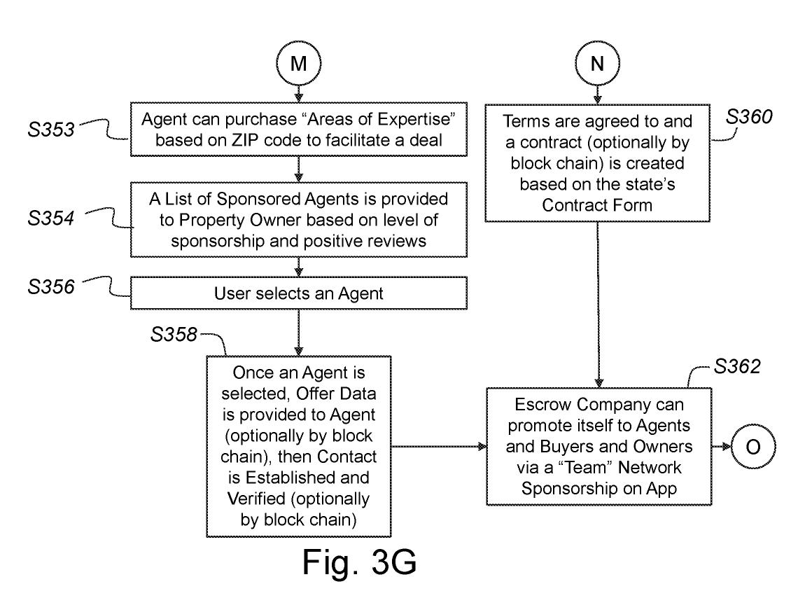

FIGS. 3A-H depict flowcharts of a process in accordance with an embodiment. In FIG. 3A, at step S302 the user downloads software application (app) 150 to computer 101, which may be, for example a smartphone. In other embodiments, computer 101 is a tablet, a laptop computer, a wearable device, a smart watch, smart glasses, or any other portable computing device. At step S304 the user launches app 150.

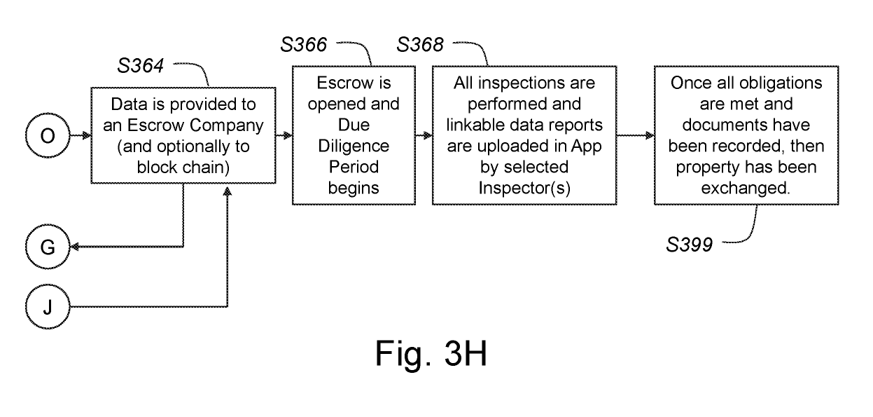

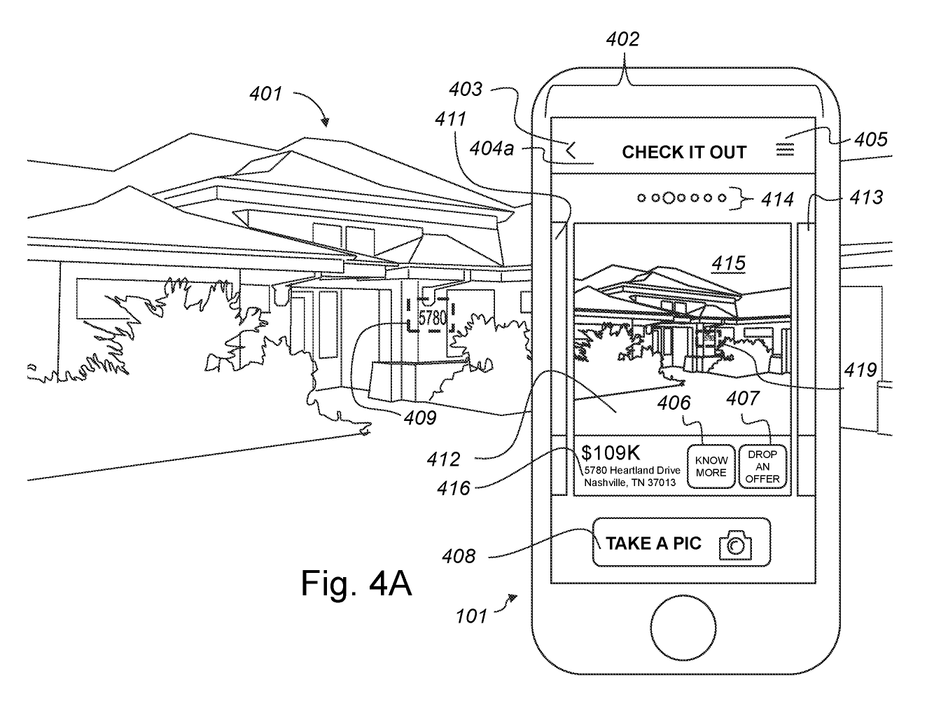

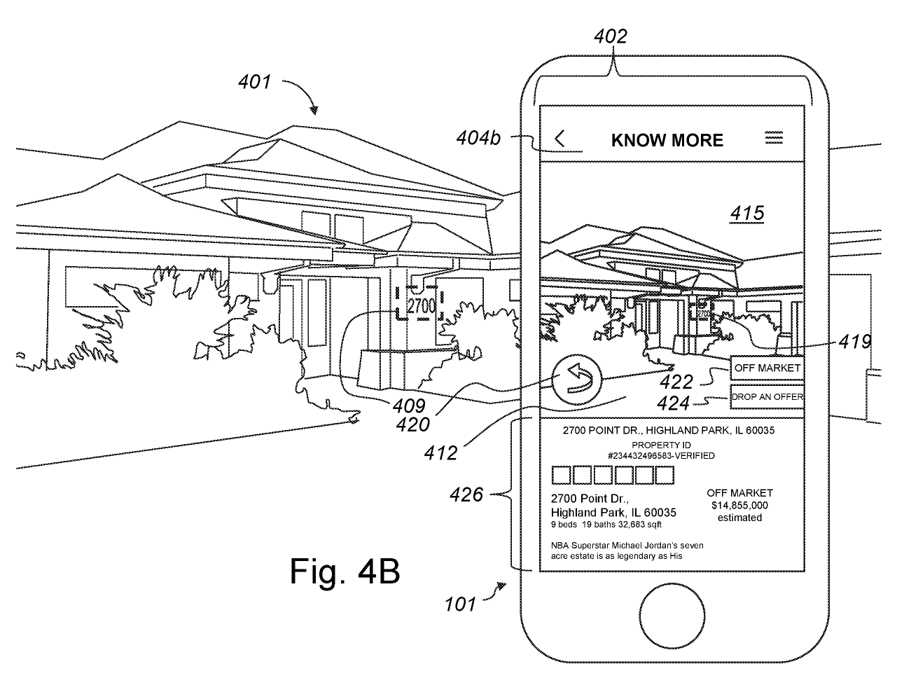

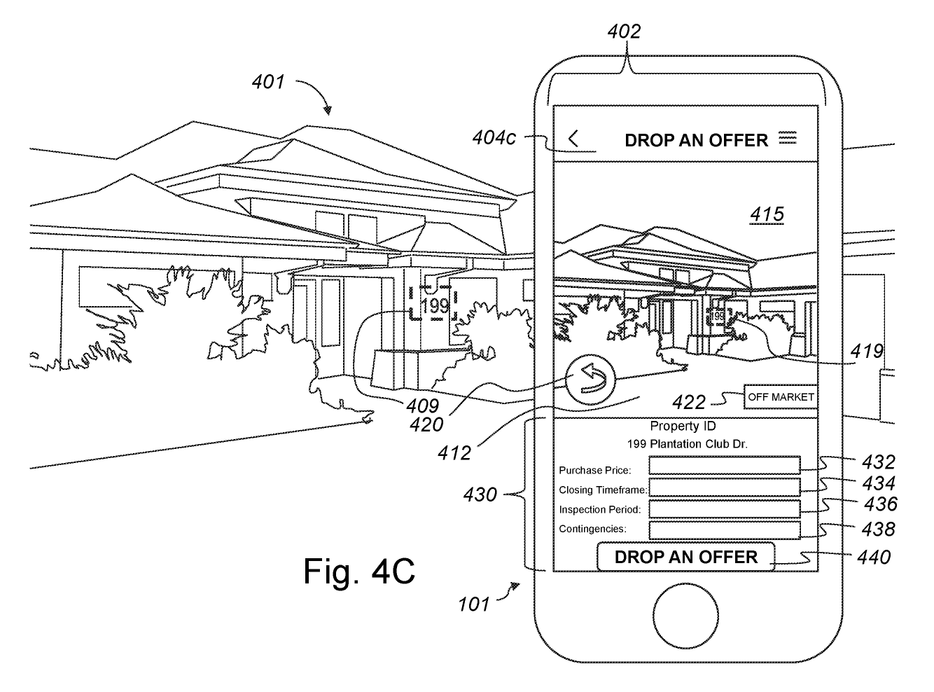

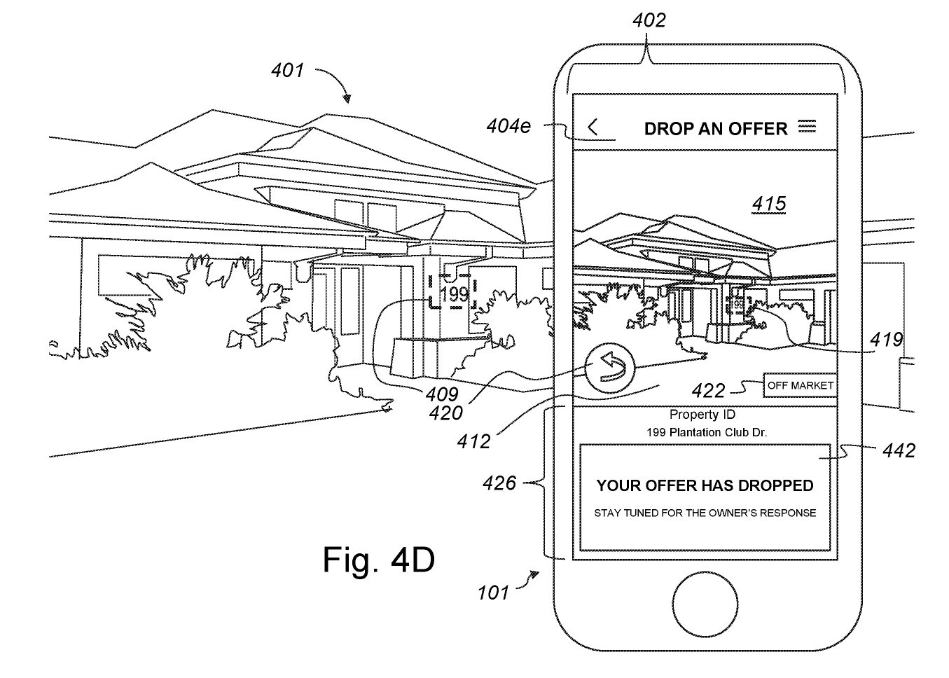

FIGS. 4A-D illustrate a user interface of a mobile device running the application viewing a house. The description is discussed in connection with the steps of the FIGS. 3A-H and the device, application and property of FIGS. 4A-D. At step S306 the user approaches a property 401 (see FIGS. 4A-4D), for example, and takes a picture 415 (see FIGS. 4A-4D) of the property 401 using built-in camera 129 of computer 101. At step S308 app 150 determines the address of the property 401 based on coordinates received by receiver 125 from a global navigation satellite system 127 (e.g., GPS, GLONASS, Galileo). In some embodiments, cellular tower triangulation is also used to determine the location of the property. In other embodiments, system 127 is a terrestrial radio location system, a Bluetooth beacon system, or another wireless geolocation system. In some embodiments, at step S308 app 150 determines the address of the property 401 based on one or more written characters discerned by optical character recognition (OCR). For example, in some embodiments, a house number or other identifying words, numbers, or characters is visible within the field of view of camera 129. An image processing component 131 (e.g., an OCR software module, a dedicated signal processor, an artificial intelligence (AI) routine executing on a remote computer) uses pattern recognition or another known technique to identify and discern letters, numbers, or other characters within the frame of the picture 415 to aid in automatically identifying the subject property 401. Thus, according to various embodiments, information is automatically extracted from an image, picture 415 of the property. In some embodiments, one or more sensors, for example magnetometers and/or accelerometers are used to aid in discerning the orientation of the camera 129 when the picture 415 is taken. App 150 returns a geographic address, such as a street address, of the property to the user. As described below, the corresponding information can be retrieved from a remote database by provided the geographic location.

In some embodiments, the user confirms whether the address is correct or not. For example, at step S312, if the address is inaccurate, App 150 permits the user to manually enter a geographic location, for instance a street address, of the property 401. If the address is correct, at step S310 App 150 retrieves the corresponding Internet Data Exchange (IDX) information, e.g., Multiple Listing Service (MLS) information, for the property 401.

Referring to FIG. 3B, at step S314 App 150 presents to the user the IDX information. In some embodiments, the IDX information is received from a Block Chain information database. In some embodiments, the IDX information is verified by the Block Chain.

The user may view the information provided and request additional information (S321a), make an offer to purchase the property (S321b), or take other actions (e.g., S321c). At step S316 App 150 determines whether the Property 401 is listed on the IDX Feed (e.g., on the MLS). If the Property 401 is already listed in the IDX Feed (e.g., on the MLS), at step S318 App 150 permits the user to make one or more inquiries such as requesting more information at step S321a, scheduling a showing at step S321c, requesting representation by an agent (i.e., in order to pursue the property with the agent's assistance) at step S319, or submitting an offer to purchase the property at step S321b. At step S320 and steps S321a-c App 150 addresses the inquiry to the listing agent provided in the IDX feed.

If more information is requested, at step S322 the listing agent or the sponsored agent receives a notification based on information (e.g., text) the user entered into form fields in App 150. In such cases, upon receiving the notification, at step S324 (follow (E) to FIG. 3D) the agent may email the user or respond with the requested information. The agent also has an option to schedule a showing which provides the user with suggested dates and times from the agent. If the user accepts, then at step S326 the showing is scheduled and both parties are notified.

If the user requested the scheduling of a showing (S321c), at step S328 the listing agent receives a notification based on text the user entered into a form field, for example, that includes the best times and dates to show the property. At step S330 (follow (F) to FIG. 3D) the agent and user confirm dates and the location to meet and a list of properties to see. At step S332 a showing reminder is sent to the user from the agent with the list of properties and the IDX information of the properties so that a comparative market analysis (CMA) can be provided. Information on the specific property as well as the CMA will be provided, which includes a home valuation. At step S334 once a showing has been performed, a notification or email is sent to the user to rank properties (i.e., in order to establish which properties the user liked most so that the agent can schedule second showings or alternatively, eliminate properties from the list) and to determine whether the user would like to submit an offer.

If the user wishes to submit an offer at step S321b, the user, i.e., potential buyer, at step S336 is provided a client market analysis based on property address, valuation information, and/or other geospatial information obtained from suitable property information sources. A non-exhaustive list of suitable information sources includes municipal or county geospatial information system (GIS) websites, real estate websites such as Zillow.com, IDX information, and tax rolls. In some embodiments, such information sources reside on one or more remote databases. By querying a remote database, a system according to an embodiment can retrieve information corresponding to a given geographic location. The listing agent or sponsored agent receives a notification based on information, such as text, entered into form fields that includes bullet point items of the types found in most deal notes, such as purchase price, deposit amounts, financing terms, closing dates, inspection requests, survey requests, title company selection, etc. In some implementations, this occurs via the Block Chain. At step S339 data fields are then provided (potentially via the Block Chain) to the agent to draft an offer based on the user's data and the rest of the information may be filled out by the agent and submitted to the user for review. Thus, according to some embodiments, at least one term of offer to purchase the property is transmitted to the owner via the agent.

If the property is not listed on MLS, at step S340 the user inquiry is directed directly to the owner of the property. At step S342, utilizing IP address tracking and retargeting techniques (e.g., online advertising network, browser and mobile app cookie(s)), the owner of the property is notified via an advertisement directed to a specified IP address, i.e., the IP address of the owner's phone. In one implementation, when an offer is submitted, a physical paper letter is simultaneously drafted and automatically sent based on property tax information to the owner in case no contact is made via the IP tracking from the buyer's or agent's submitted online offer. Thus, according to various embodiments, at least one term of offer to purchase the property is transmitted to the owner initially without involving any agent.

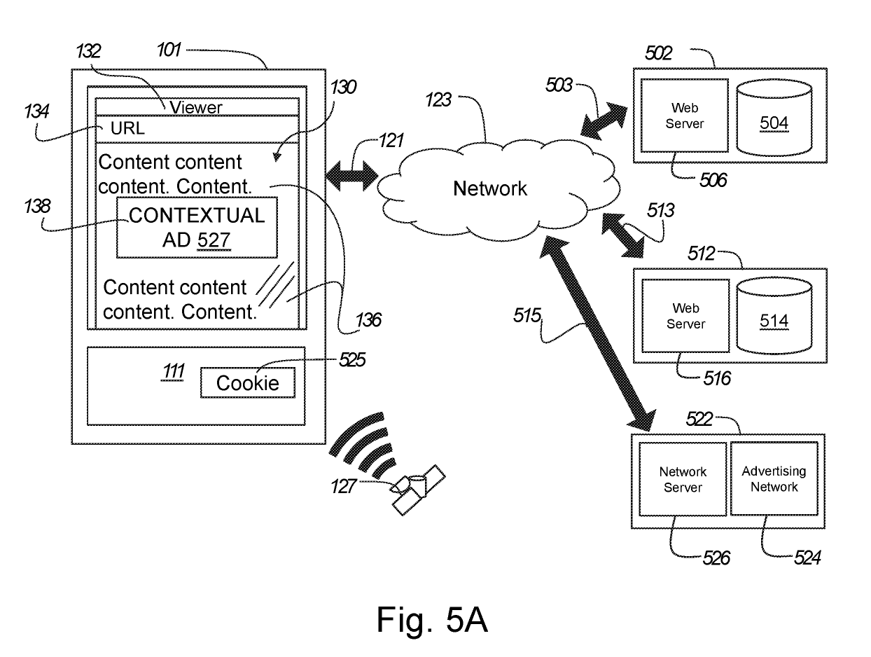

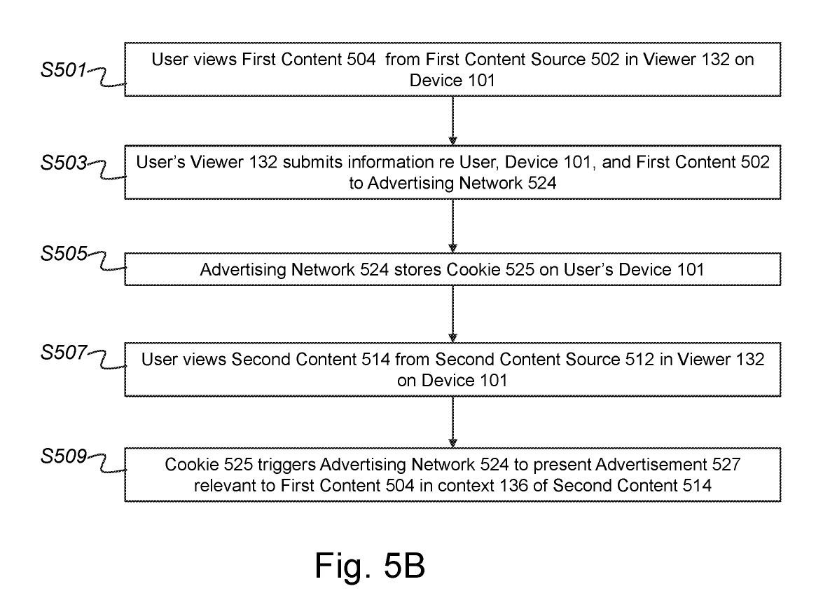

Referring to FIGS. 5A and 5B, various embodiments for performing step S342 are discussed. In an embodiment the computer 101 is a smartphone and includes a display 130. In an embodiment, display 130 presents graphical information as shapes, characters, etc., to a user, as controlled by the application (app) 150. In some embodiments, the user interacts with app 150 on computer 101 via a human interface device, e.g., touchscreen, keyboard, mouse, gesture, voice, etc. In an embodiment, app 150 includes a viewer 132 (e.g., web browser, mobile app, social network) to present content in content display regions 136 from any of various sources available over the network 123.

A first computer 502 connects to the network 123 via network link 503. A second computer 512 connects to the network 123 via a network link 513. A third computer 522 connects to the network 123 via network link 523. First computer 502 hosts first content 504 (e.g., a website, picture, video, or audio file) and a first web server 506. Second computer 512 hosts second content 514 (e.g., a website, picture, video, or audio file) different from the first content 504 and a second web server 516. Third computer 522 hosts an advertising network 524 and a network server 526.

At step S501 a user navigates to the first web server 506, for example by clicking a hyperlink or entering an address in the uniform resource locator (URL) field 134, and viewer 132 receives first content 504 from computer 502. Viewer 132 displays first content 504 in content display regions 136. At step S503 viewer 132 also submits information (e.g., metadata) about the first content 504, the user's computer 101 (e.g., MAC address), the session (e.g., IP address), and/or the user's location (e.g., GPS coordinates) to the advertising network 524.

At step S505 advertising network 524 sends a tracking code or cookie (e.g., browser cookie) 525 to be stored on the user's computer 101. In various embodiments, cookie 525 encodes the information (e.g., metadata) submitted by viewer 132.

At step S507, when the user navigates to the second web server 516, for example by clicking a hyperlink or entering an address in URL field 134, viewer 132 receives second content 514 from computer 512. Viewer 132 displays second content 514 in content display regions 136. In some embodiments, viewer 132 also submits information (e.g., metadata) about the second content 514, the user's computer 101 (e.g., MAC address), the session (e.g., IP address), and/or the user's location (e.g., GPS coordinates) to the advertising network 524.

At step S509, when viewer 132 displays the second content 514, cookie 525 triggers advertising network 524 to compose and send a contextual advertisement 527 (e.g., banner ad, pop-up ad, sidebar ad, video overlay ad) relevant to first content 504 to be displayed by viewer 132 in the context (e.g., web site, social network, mobile app) of the second content 514 in a contextual display region 138.

Other embodiments for performing step S342 are known in fields including online sales lead generation, digital advertising, Internet advertising, targeted social media and/or web campaigns, and automated advertisement generation using a structured data feed. According to various non-limiting embodiments, advertisers (e.g., agents), customize their advertising to track potential prospects' activities on social media and the web, to target zip codes, to create and update listings, to integrate with customer relationship management (CRM) tools and/or databases, and to specify a geographic radius for promotional listings.

Referring again to FIG. 3C, at step S344 the owner can click on the ad 527 and respond to the inquiry. At step S346 the owner can decide whether to respond to the underlying offer presented by ad 527. At step S348 the owner may also decide to opt out if they wish.

Referring now to FIG. 3D, when the owner responds to the offer, at step S350 the owner has an option to use an agent to facilitate the deal, or alternatively, to negotiate directly. At step S352 the owner negotiates directly by uploading and populating forms in the app 150.

Referring now to FIG. 3G, as shown at step S353, agents can purchase areas of expertise based on the zip code to facilitate a deal. For example, an agent can pay to become a prioritized or “top” agent, whereby the agent's name, ad, and/or contact information will be shown preferential treatment in the list of agents presented to the owner to select from. Agents need not perform step S353 after step S350 and before step S354. Instead, in many embodiments, an agent has already performed step S353 long before (e.g., days, months, or years before) the owner performs step S350.

If the owner at step S348 opts to respond to the offer and at step S350 opts to use an agent, then at step S354 a list of sponsored candidate agents is provided to the owner based on criteria including, but not limited to, the agents' level of sponsorship and positive reviews. At step S356, the user selects an agent. Once an agent has been selected, at step S358 offer data is provided to the agent, including for example, purchase price, deposit amounts, financing terms, closing dates, inspection requests, survey requests, title company selection, etc. In some embodiments, the offer data is communicated via Block Chain data. In other embodiments, the offer data is communicated via a folder of information submitted to a traditional escrow company, with an order generated by the escrow company. In still further embodiments, the escrow company and the agent are connected via an automated email sent to both.

Alternatively, if the owner opts not to have an agent (S350), the offer may be negotiated by the owner directly via the app 150 (S352). The owner may utilize capabilities of the app 150 to upload and populate forms. In this case, at step S360 the app 150 supplies a form contract of the type recognized in the state having jurisdiction over real estate transactions for the subject property. The app 150 fills-in the form contract using the terms agreed to by the prospective seller (owner) and the prospective buyer. In some embodiments, a Block Chain contract is created.

At step S362, an escrow company can promote itself to agents, buyers, and owners via a team network sponsorship in the app 150. Escrow companies need not perform step S362 after step S360 or after step S358. Instead, in many embodiments, an escrow company has already performed step S360 long before (e.g., days, months, or years before) step S358 and/or step S360 occurs.

Referring now to FIG. 3H, at step S364, data (e.g., purchase price, deposit amounts, financing terms, closing dates, inspection requests, survey requests, title company selection, etc.) are provided to an escrow company. In some embodiments, the data are also provided to the Block Chain. Next, in some embodiments, at step S366 escrow is opened and the due diligence period begins. In some states, real estate transactions have an escrow company to act as a third-party manager of the transaction. Then, at step S368 inspections are performed and linkable data reports are uploaded in the app by the selected inspector(s). At step S399 once all obligations are met and documents have been recorded, then the property has been exchanged.

Referring now to FIG. 3E, embodiments in relation to agents are discussed. At step S380 an agent downloads app 150. At step S382 the agent creates a profile. At step S384 the agent determines the locations to advertise and pays for placement in desired locations. Agents can promote themselves via IP address tracking and retargeting methods. For example, IP addresses may be tracked to specific property addresses (e.g., a user's home address). Other embodiments for performing step S386 are known in fields including online lead generation, digital advertising, Internet advertising, targeted social media and/or web campaigns, and automated advertisement generation using a structured data feed. According to various non-limiting embodiments, advertisers (e.g., agents) promote themselves using automated systems to track potential prospects' activities on social media and the web, to target zip codes, to create and update property listings, to integrate with customer relationship management (CRM) tools and/or databases, and to specify a geographic radius for promotional listings.

At step S388 the agent can pay to be a contract specialist which provides the agent with first look opportunities. At step S390 a first look opportunity allows an agent to be selected when an offer is submitted by a buyer. At step S392 a user or owner can select the agent and the agent will be opted first (i.e., the user will be more likely to select the agent because the agent appears earlier in the list of prospective agents to be selected) as the agent for the transaction.

Referring to FIG. 3F, at step S393 if both buyer and seller elect to use the same agent, then at step S395 a dual agency agreement is drafted. In the alternative, at step S394 the owner can decide to select another agent from a sponsored list to represent them.

At step S396 the owner can propose commission offers directly to the agent(s) and agent(s) can negotiate the commission amount based on the strength of the offer. At step S397 agent, owner, and/or buyer can agree to terms and draft a representation agreement which can be uploaded and electronically signed in the app 150. The owner and agent(s) can agree to a commission via the app 150. As shown in step S398, an offer can be negotiated via the app 150. In particular embodiments, the app 150 has the ability to upload and populate forms.

Referring now to FIGS. 4A-4D, a user experience according to an embodiment is shown. In an embodiment, the computer 101 is a smartphone. When the user (i.e., a prospective buyer, a prospective seller, a prospective agent) launches the app 150 (see step S304) a graphical display 402 is presented. In an embodiment, graphical display 402 includes a GO BACK button 403 permitting a user to return to an earlier view and an OPTIONS button 405 permitting the user to customize the user experience by selecting options (e.g., font size, data connection type, user profile, etc.). CHECK IT OUT view 404a appears in graphical display 402 to show one or more items in a property list as interactive tiles 411, 412, 413, etc. spaced apart along a horizontal axis. List navigation indicator 414 shows the active tile (in this case interactive tile 412) as an enlarged mark in a series of small marks arranged parallel to the interactive tiles, so as to suggest the placement of the active tile (412) in relation to other tiles (411, 413, etc.) corresponding to other properties in the list.

In CHECK IT OUT view 404a, the user can approach a property 401 (e.g., drive by the property 401, walk on a sidewalk near the property 401) and take a picture 415 of the property 401 using TAKE A PIC button 408. (See step S306.) App 150 determines the subject property's address based on the GPS (or similar radio navigation) coordinates of the subject property as discussed in relation to FIG. 3A. The picture 415 is displayed in the active tile 412 with a description 416 of the property 401. CHECK IT OUT view 404a also includes a KNOW MORE button 406 and a DROP AN OFFER button 407. Pressing the KNOW MORE button 406 leads to a KNOW MORE view 404b (FIG. 4B). Pressing the DROP AN OFFER button 407 leads to a DROP AN OFFER view 404c (FIG. 4C).

Referring to FIG. 4A, property 401 includes a house number 409 including a series of numerals: 5, 7, 8, and 0. The image processing component 131 takes the picture 415 as an input and provides as output a detected character string 419 the ordered sequence of numerals: 5, 7, 8, and 0. From this, the app 150 searches for property information based not only on the GPS location, but also based on the house number 409, having a value of “5780.” In like manner, the image processing component recognizes a detected character string 419 of “2700” in FIG. 4B and “199” in FIGS. 4C and 4D.

Referring to FIG. 4B, in the KNOW MORE view 404b, the active tile 412 expands to fill the graphical display 402. Where three-dimensional imagery (e.g., 360-degree, virtual reality (VR), augmented reality (AR)) is available, a 3D navigation button 420 is displayed over the picture 415. Pressing the 3D navigation button 420 activates three-dimensional imagery. In some embodiments, tile 412 updates to display new information and/or imagery in an AR view, whereby the picture 415 is a live view from the camera 129 and relevant information is overlaid on the picture 415. In such embodiments, when the user moves the computer 101 to be pointed at a different property (e.g., an adjacent or “next-door” property) the information in the KNOW MORE view 404b updates to correspond to the different property.

A market status flag 422 is displayed over picture 415 to indicate the property's current status (e.g., off market, coming soon, under contract, just sold, etc.). In some embodiments, pressing the market status flag 422 causes additional information (e.g., more detailed explanation of the property's market status) to be displayed. A DROP AN OFFER button 424 leads to DROP AN OFFER view 404c (FIG. 4C). An expanded description 426 describes the property 401 in greater detail than the description 416. In some embodiments, expanded description 426 is scrollable, i.e., it will scroll to reveal additional information in response to a touch gesture, a keyboard keystroke, a mouse click, or the like.

Referring to FIG. 4C, in the DROP AN OFFER view 404c, DROP AN OFFER button 424 is replaced by a DROP AN OFFER button 440 at the bottom of a data entry form 430. In the data entry form 430, a user may input terms relevant to a prospective offer. In a non-limiting embodiment, data entry form 430 includes a purchase price field 432, a closing timeframe field 434, an inspection period field 436, and a contingencies field 438. One or more of the fields 432-438 may refer to an underlying database object of various types including short string, long text, integer, decimal, date, etc. Pressing the DROP AN OFFER button 440 submits the terms of the offer for transmission to the owner (prospective seller).

Referring to FIG. 4D, upon successful submission, the app 150 displays a notice 442, including an appropriate message such as “YOUR OFFER HAS DROPPED. Stay tuned for the owner's response.”

In some embodiments, the app 150 runs natively on the user's computer 101. In other embodiments, the app runs remotely as a web application or as software as a service (SAAS), offloading one or more tasks to a remote computing device. For example, in some embodiments, image processing is performed remotely.

The foregoing description of various embodiments provides illustration and description, but is not intended to be exhaustive or to limit the invention to the precise form disclosed. Modifications and variations are possible in light of the above teachings or may be acquired from practice in accordance with the present invention. For example, features disclosed with respect to one embodiment may be combined with features of other embodiments without departing from the scope of the disclosure.

1. A method in a data processing system for retrieving real estate information and automatically delivering an inquiry to purchase real estate, comprising:
acquiring an image of a property by a camera of a mobile computing device;
determining a geographic location of the property by the mobile computing device;
retrieving property information corresponding to the geographic location by the mobile computing device from a database;
determining from the property information a contact information for an owner of the property; and
transmitting to the owner a communication regarding the property based on the contact information.

2. The method of claim 1, wherein transmitting to the owner a communication regarding the property based on the contact information further comprises:
transmitting to the owner at least one term of the offer to purchase the property based on the contact information.

3. The method of claim 1, further comprising extracting information from the acquired image to determine the geographic location and the property information of the property.

4. The method of claim 3, wherein extracting the information from the acquired image further comprises extracting a house number from the image of the property.

5. The method of claim 1, wherein the property information includes an address of the property.

6. The method of claim 5, further comprising displaying the address of the property to a user.

7. The method of claim 1, wherein the property information includes Internet Data Exchange information.

8. The method of claim 1, further comprising transmitting to the owner one of: (1) a request for more information about the property, and (2) a request to schedule a showing of the property.

9. The method of claim 1, further comprising receiving a network address of a computer used by the owner of the property.

10. The method of claim 9, wherein the network address of a computer used by the owner of the property is received from an advertising network.

11. The method of claim 10, wherein the advertising network determines the network address of the computer used by the owner of the property from a tracking code stored on the computer used by the owner of the property.

12. The method of claim 1, wherein the database is a block chain information database.

13. The method of claim 1, further comprising promoting a contact information of a real estate agent from among a list of real estate agents.

14. The method of claim 1, further comprising promoting a contact information of an escrow company from among a list of candidate escrow companies.

15. The method of claim 1, further comprising selecting a real estate agent from a list of real estate agents for the offer.

16. The method of claim 2, wherein the transmitting to the owner the at least one term of offer to purchase the property includes sending a physical message.

17. A data processing system for retrieving real estate information and automatically delivering an inquiry to purchase real estate, comprising:
a mobile computing device comprising:
a camera;
a processor; and
a memory storing instructions that, when executed by the processor, configure the mobile computing device to:
acquire an image of a property by the camera of the mobile computing device;
determine a geographic location of the property;
retrieve property information corresponding to the geographic location from a database;
determine from the property information a contact information for an owner of the property; and
transmit to the owner a communication regarding the property based on the contact information.

18. The data processing system of claim 17, wherein the instructions further configure the processor to transmit to the owner at least one term of the offer to purchase the property based on the contact information.

19. The data processing system of claim 17, wherein the instructions further configure the processor to extract information from the acquired image to determine the geographic location and the property information of the property.

20. The data processing system of claim 19, wherein extracting the information from the acquired image further comprises extracting a house number from the image of the property.

21. The data processing system of claim 17, wherein the property information includes an address of the property.

22. The data processing system of claim 20, wherein the instructions further configure the processor to display the address of the property to a user.

23. The data processing system of claim 17, wherein the property information includes Internet Data Exchange information.

24. The data processing system of claim 17, wherein the instructions further configure the processor to transmit to the owner one of: (1) a request for more information about the property, and (2) a request to schedule a showing of the property.

25. The data processing system of claim 17, wherein the instructions further configure the processor to receive a network address of a computer used by the owner of the property.

26. The data processing system of claim 25, wherein the network address of a computer used by the owner of the property is received from an advertising network.

27. The data processing system of claim 26, wherein the advertising network determines the network address of the computer used by the owner of the property from a tracking code stored on the computer used by the owner of the property.

28. The data processing system of claim 17, wherein the database is a block chain information database.

29. The data processing system of claim 17, wherein the instructions further configure the processor to promote a contact information of a real estate agent from among a list of real estate agents.

30. The data processing system claim 17, wherein the instructions further configure the processor to promote a contact information of an escrow company from among a list of candidate escrow companies.

31. The data processing system of claim 17, wherein the instructions further configure the processor to select a real estate agent from a list of real estate agents for the offer.

32. The data processing system of claim 17, wherein the transmitting to the owner the at least one term of offer to purchase the property includes send a physical message.
